(19) United States
(12) Patent Application Publication
(10) Pub. No.: US 2023/0385654 A1
(43) Pub. Date: Nov. 30, 2023

(54) MODEL-PREDICTIVE CONTROL OF PEST PRESENCE IN HOST ENVIRONMENTS

(71) Applicant: X Development LLC, Mountain View, CA (US)

(72) Inventors: Bethany Johnson, Santa Monica, CA (US); Haoyu Zhang, San Marino, CA (US)

(21) Appl. No.: 17/824,753

(22) Filed: May 25, 2022

(51) Int. Cl. G06N 3/12

(52) U.S. Cl. CPC G06N 3/126; A01M 99/00

(57) ABSTRACT

Systems and methods for controlling a population of a pest are provided. A computer implemented method for controlling a population of a pest can include receiving population data describing a presence of a pest in a host environment at a first time. The method can include receiving environmental data describing the host environment over a prediction horizon including and temporally after the first time. The method can include generating an intervention action for the first time using the population data and the environmental data as inputs to a control model configured to output the intervention action as part of an optimization of the presence of the pest over the prediction horizon. The method can also include outputting the intervention action.

### TECHNICAL FIELD

This disclosure relates generally to sensor systems, and in particular but not exclusively, relates to systems and techniques for monitoring and predictive control of pest populations.

### BACKGROUND INFORMATION

Many important agricultural pests are insects. The study of biological life cycles, such as the developmental cycles of insects, is known as phenology, and many phenological models exist for different pest insect species. The overall goal of pest modeling is to predict aspects of insect population dynamics within a season to inform management decisions, such as the timing of pesticide applications or other interventions. Accurate prediction of interventions is crucial for pest management, can help reduce pesticide use, and can reduce crop damage by enabling more precise application.

Insect pests pose a major threat to agricultural systems and food security. Despite widespread effort to mitigate the impacts of insects, pest management remains challenging. In practice, management typically involves corrective actions that are too late to avert damage. For example, insect pests destroy approximately 20% of global grain crops every year through a combination of direct damage (e.g., consumption) and indirect damage (e.g., spreading disease and parasites). Typically, interventions such as spraying or trapping are implemented in response to a threshold change in population or emergence of a pest, or by following a set schedule.

Pest intervention remains a labor intensive and challenging process. For example, typical techniques for pest intervention, such as reactive methods or intervention scheduling, do not account for effects of interventions on pest populations, the host environment, or competing objectives including resource allocation and regulatory compliance. There remains a need, therefore, for a predictive approach that integrates physical constraints and competing objectives to significantly reduce insect pest emergence with fewer interventions than the conventional reactive and/or scheduled approaches.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified. Not all instances of an element are necessarily labeled so as not to clutter the drawings where appropriate. The drawings are not necessarily to scale, emphasis instead being placed upon illustrating the principles being described.

FIG. 1 is a schematic diagram illustrating components of an example system for controlling a population of a pest, in accordance with embodiments of the disclosure.

FIG. 2 is a process flow diagram illustrating an example process for controlling a population of a pest, in accordance with embodiments of the disclosure.

FIG. 3 is a data flow diagram illustrating an example control system for generating intervention actions, in accordance with embodiments of the disclosure.

FIG. 4A is a schematic diagram illustrating example environmental data, in accordance with embodiments the disclosure.

FIG. 4B is a schematic diagram illustrating example state data and intervention data, in accordance with embodiments the disclosure.

FIG. 5 is a schematic diagram illustrating example data flows of an open loop optimization of predicted state data and intervention actions to generate an intervention action, in accordance with embodiments of the disclosure.

FIG. 6A is an example population graph illustrating example population data as a function of time in a system without intervention, in accordance with embodiments of the disclosure.

FIG. 6B is an example population graph illustrating example population data as a function of time in a system with reactive intervention, in accordance with embodiments of the disclosure.

FIG. 6C is an example population graph illustrating example population data as a function of time in a system with predictive intervention described in reference to FIGS. 1-5 and FIG. 7, in accordance with embodiments of the disclosure.

FIG. 7 is a block flow diagram illustrating an example method for controlling a population of a pest, in accordance with embodiments of the disclosure.

In the above-referenced drawings, like reference numerals refer to like parts throughout the various views unless otherwise specified. Not all instances of an element are necessarily labeled to simplify the drawings where appropriate. The drawings are not necessarily to scale, emphasis instead being placed upon illustrating the principles being described.

### DETAILED DESCRIPTION

Embodiments of a system, a method, and computer executable instructions for model-predictive control of a population of a pest in a host environment are described herein. In the following description, numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics can be combined in any suitable manner in one or more embodiments.

Insect pests pose a major threat to agricultural systems and food security. Despite widespread effort to mitigate the impacts of insects, pest management remains challenging. In practice, management typically involves corrective actions that are too late to avert damage. For example, insect pests destroy approximately 20% of global grain crops every year through a combination of direct damage (e.g., consumption) and indirect damage (e.g., spreading disease and parasites). Typically, intervention includes implementing an intervention in response to a threshold change in population or emergence of a pest, or by following a set schedule.

The study of biological life cycles, such as the developmental cycles of insects is known as phenology, and there are many existing phenological models for various pest insect species. The overall goal of pest modeling is to predict various aspects of insect population dynamics within a season to inform management decisions, such as the timing of pesticide applications or other interventions. Since most insects cannot reliably maintain constant body temperature, insect life cycle and population dynamics are strongly dependent on environmental conditions, such as ambient temperature. A widely used method of quantifying the relationship between temperature and insect biology makes use of a parameter referred to as growing degree days (GDDs). GDDs describe a measure of time and temperature for which the ambient temperature exceeds the lower developmental temperature threshold.

Models based on GDD estimates rely on heuristics developed in laboratory conditions that, while simple and easy to implement, incorporate simplifying assumptions to reduce the number of parameters and cross-coupling of environmental factors. Such simplifications introduce error and significantly limit the flexibility of the GDD models to adapt to in situ growing conditions. For at least this reason, pest intervention prediction and timing remain a labor intensive and challenging process. As a result, pest management systems typically rely on reactive intervention, based on pest population measurements rising above a threshold value or rate, or by scheduled interventions that do not adapt to in situ conditions.

GDD models can be calibrated using field measurements, requiring multiple pest trap measurements over multiple days, but only a limited set of models are available for each pest/host combination, and empirical models cannot be adapted for events that are not simulated in laboratory conditions. For example, empirical models used to predict pest populations do not account for effects of interventions on pest populations, the host environment, or competing objectives including allocation of limited intervention resources or regulatory compliance. There remains a need, therefore, for a predictive approach that integrates physical constraints and competing objectives to significantly reduce insect pest abundance with fewer interventions than the conventional reactive and/or scheduled approaches.

In an illustrative example, many insect pests have distinct generations within one season, referred to as multivoltinism. Different generations manifest as distinct population peaks in observations from a particular season or year. Knowledge about the emergence of each generation is important when managing many pests, as the generations can have distinct biology and interactions with crops. Timing, type, and extent of interventions can be optimized to reduce the overall impact of a pest on the environment (e.g., crop damage) as well as to balance competing objectives (e.g., intervention equipment usage, cost of materials, environmental impact of interventions).

In the context of almond cultivation, the first generation of navel orangeworm typically lays eggs on old fruits left over from the previous year and does not directly damage future harvests. Subsequent generations in the same orchard, however, tend to be synchronized with the development of new fruit and cause significant crop damage. In this example, interventions can differ between pest generations. For example, the first generation can be treated to trap adult insects (e.g., using pheromone traps), while a second generation can be treated to reduce egg or larval numbers (e.g., by spraying), before the pest is established or proliferates in an orchard. In some embodiments, interventions include targeted chemical interventions, such as mating disruption, that do not kill insects directly, but rather prevent/reduce reproduction as an approach to limit the proliferation of the targeted pest.

In reference to the forthcoming paragraphs, description of embodiments focuses on navel orangeworm (Amyelois transitella, a type of moth) infestation of almond orchards as an example pest/host combination, but alternative applications are contemplated where model predictive control can be applied to control pest population through optimization of intervention timings in line with competing objectives. In general, the techniques described can be applied to pest/host systems for which some ground-truth data is available, for example, through regular albeit infrequent visits by human inspectors, that can be supplemented with rich environmental datasets including historical data, current data, and/or predicted data.

Examples of alternative pest/host systems can include, but are not limited to, flying insects (e.g. Lepidoptera, Cynipidae, Diptera) and/or non-flying insects (e.g. Aphidae, Lygus). In some embodiments, non-animal pests can also be modeled in addition to or in place of insect pests. For example, non-insect pests include but are not limited to weeds (e.g., invasive, parasitic, competitor, or otherwise undesirable plants) and plant diseases (e.g., fungal, bacterial, protozoan, viral, etc.). In some embodiments, different models apply to different pest types, corresponding to characteristic growth and proliferation dynamics.

As such, the techniques described herein (e.g., predictive model control incorporating machine-learning and/or mechanistic models), can be adapted to a given pest/host system. In situ environmental conditions and the complex interactions between the measured and/or predicted environmental parameters can serve as inputs to predictive models paired with optimizer models to converge a constraint model to a target value (e.g., as part of a minimization algorithm). The constraint model can be used to introduce one or more competing objectives. Through optimization of predicted pest population in tandem with the competing objective(s) over a moving prediction horizon, an intervention action at a current time can be generated that both reduces the overall impact of the pest on the host environment and reduces the equipment/resource demand of intervention strategies and the environmental impact of interventions, among other competing objectives.

In this way, environmental data and pest population data can be leveraged to predict future population inputs for optimizer control models. The optimizer models, in turn, can be configured to generate intervention actions as part of an optimization of pest population and competing objectives over a prediction horizon. Intervention data, such as the economic, resource, and time demands of diverse types of interventions can be included as part of constraint models. Such diverse inputs permit model predictive control techniques to be used to determine which intervention action to take and/or whether to take an intervention action at a given time period during a growing season. In the context of this disclosure, the term “intervention action” describes one or more operations undertaken by a pest management system including planning, scheduling, and executing an intervention, which can include spraying, deploying natural predators, deploying traps, etc.

In an illustrative example, a pest monitoring system of pheromone traps can be used to estimate the population density of navel orangeworm in an almond orchard. A control model can include a predictive model configured to predict future pest populations using intervention data, population data, and environmental data, and an optimizer model configured to generate a set of intervention actions over the prediction horizon. An intervention action can be generated based at least in part on optimizing the set of predicted invention actions using a constraint model (e.g., minimizing a “cost” function, where cost refers to non-economic costs). The process of generating and/or receiving pest population data, environmental data, and prior intervention data can be repeated iteratively as part of a control scheme to actively manage predictive interventions, rather than applying a reactive or pre-scheduled intervention process. Advantageously, the techniques and systems described herein improve the performance of pest management systems at least in part by reducing the number of interventions and the emergence of pests.

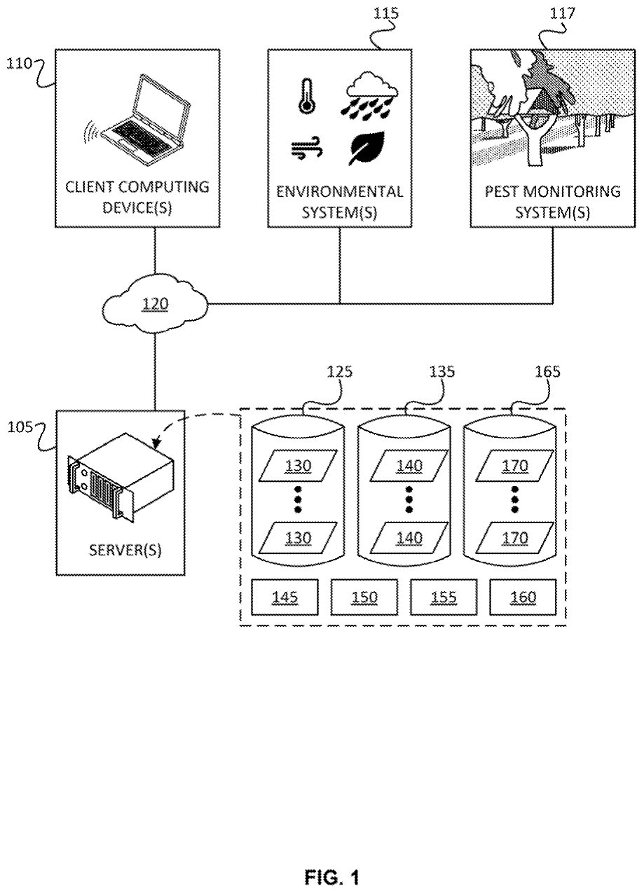

FIG. 1 is a schematic diagram illustrating components of an example system 100 for controlling the population of a pest, in accordance with embodiments of the disclosure. Example system 100 includes: one or more servers 105, one or more client computing devices 110, one or more sources of environmental data 115, one or more pest monitoring systems 117, and a network 120. The server(s) 105 include: a first database 125 of environmental data 130, a second database 135 of pest population data 140, one or more constraint models 145 and one or more predictive models 150 encoded in software 155. As part of software 155, server(s) 105 include instructions by which models 145-150 are configured and/or deployed using computer circuitry 160. In some embodiments, server(s) 105 further include a third database 165 storing intervention data 170 that describes intervention actions that have been implemented corresponding to one or more agricultural regions (e.g., as part of a spatially localized pest management system).

The following description focuses on embodiments implementing a networked system for configuring and/or deploying models 145-150 for generating predicted population density and intervention predictions for a given pest/host combination over a prediction horizon, and for optimizing the intervention predictions using one or more optimization criteria to determine an intervention action to be taken. It is contemplated, however, that some embodiments of the present disclosure include some or all of the processes being implemented on client computing device(s) 110, such as a laptop, smartphone, or personal computer. For example, configuration and development of models 145-150 can be implemented using server(s) 105, while completed models 145-150 can be transferred to client computing device 110 via network 120 and can be deployed directly on client computing device 110. Similarly, the constituent elements of example system 100 can be hosted and/or stored on a distributed computing system (e.g., a cloud system) rather than in a unitary system. For example, first database 125, second database 135, third database 165, and/or computer circuitry 160 can be implemented across a distributed system, such that portions of environmental data 130, population data 140, software 155, and/or intervention data 170 can be stored or executed by a distributed computing system in one or more physical locations.

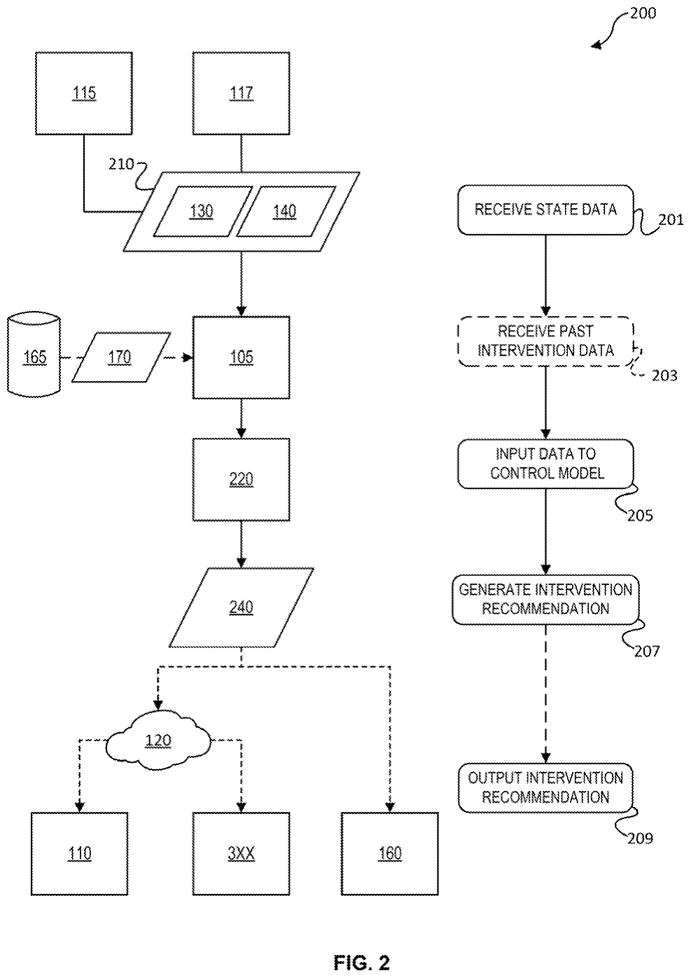

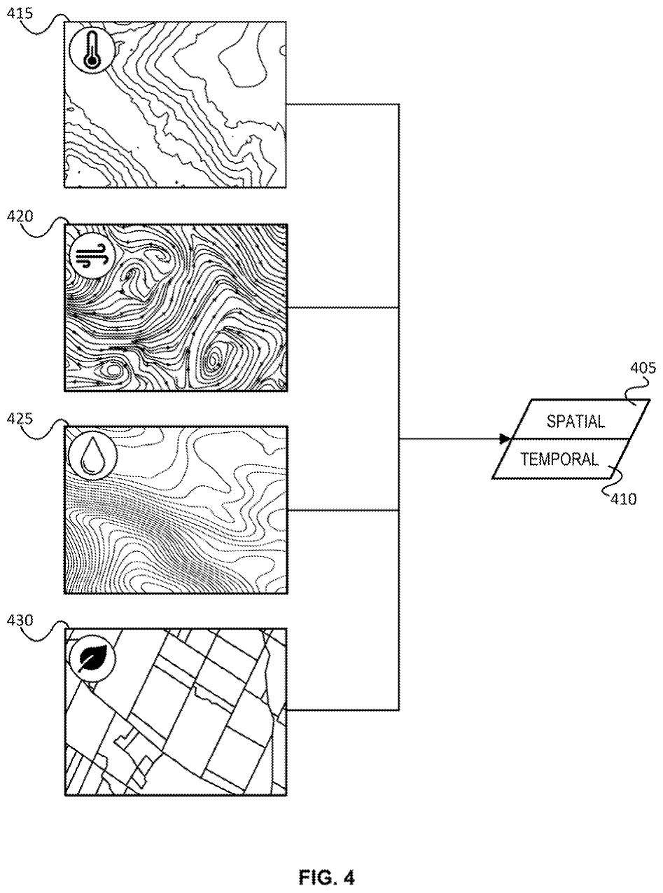

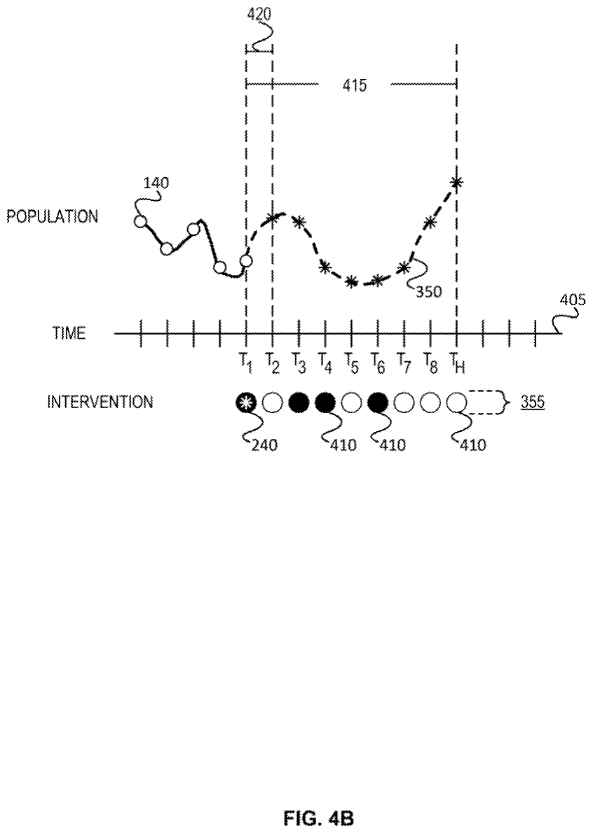

In an illustrative example of the operation of example system 100, server(s) 105 and/or client computing device(s) 110 receive state data 210 (in reference to FIG. 2) including environmental data 130 describing conditions and physical characteristics of a host environment that are measured and/or predicted by sources 115 and/or pest population data 140 describing the presence and/or abundance of a pest in the host environment that is measured by pest monitoring system 117. The presence of the pest can include whether the pest is present at all (e.g., a “true” or “false” value) as well as an estimate of pest population density in the host environment. Environmental data 130 can be or include meteorological data, hyperspectral data, topographic data, segmented and/or classified image data, or the like, as described in more detail in reference to FIG. 4A. Environmental data 130 can be accessed, received, and/or stored locally on client computing device 110. Additionally or alternatively, environmental data 130 can be accessed, received, and/or stored on server(s) 105 via network 120.

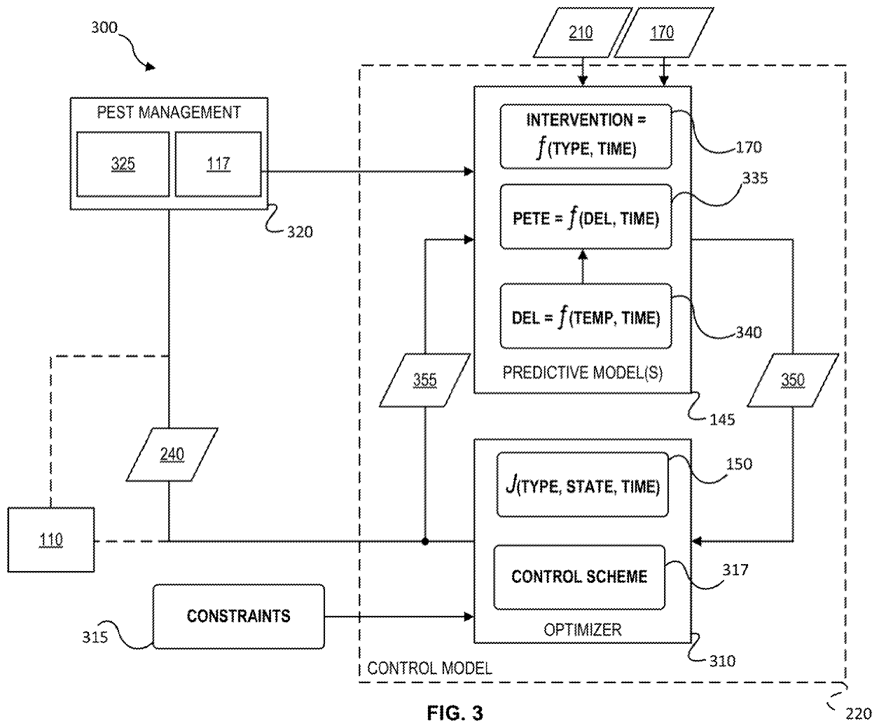

Control models include predictive models 145 that are configured, trained, and/or prepared to input environmental data 130 and to output predicted population data, which can be pushed to user devices, such as client computing device 110. In some embodiments, example system 100 is configured to implement automated procedures, such as scheduling interventions, implementing interventions, generating notifications to be presented to users of client computing devices 110, through direct control communication with automated or pseudo-automated pest management systems 320 (in reference to FIG. 3). In this context, automated refers to operation without human involvement (e.g., as an autonomous vehicle configured to implement an intervention, such as spraying), and pseudo automated refers to a system that implements one or more automatic actions and also includes some human involvement (e.g., a system that prepares for an intervention and includes a human user to implement the intervention, such as a human driver of a spraying system).

In the context of example system 100, sources of environmental data 115 are represented by a collection of visual symbols (e.g., a thermometer), to simplify visual explanation. Sources of environmental data 115 include, but are not limited to, in situ sensors, orbital imaging/spectroscopy platforms, meteorological models or data collection systems, and/or user-labeled data. As an illustrative example, sources of environmental data 115 can include in situ sensors for ambient temperature, humidity, carbon dioxide, chemical pollution, GPS location, wind speed, atmospheric pressure, or the like (e.g., as in a meteorological sensor station). In some embodiments, sources of environmental data 115 also include meteorological predictions for the host environment generated by a weather model. Environmental data 130 can be localized to a physical area by correlating physical locations of sensors (e.g., GPS data) with extent information describing the physical space where host vegetation is grown (e.g., the metes and bounds of an almond orchard within a polyculture agricultural region).

Extent information can be generated by manual labeling of map data and/or satellite images (e.g., hyperspectral images indicating spatial variation in water content), automated (e.g., without human intervention) classification/segmentation of satellite images, or through communication of planting data with agricultural systems, such as planting systems that include internet-connected systems. In an example, a planter can include a GPS sensor and an interne connected computer system that can generate planting data describing locations and seed identifier information for planting operations. In turn, the planting data can be shared with example system 100 as part of environmental data 130.

Pest population data 140 can be collected as part of the operation of pest monitoring system 117 by various sampling methods used by growers. For example, pheromone traps, egg traps (for flying insects, e.g. Lepidoptera), suction traps (for aphidae) or bucket sampling and/or sweep sampling (e.g., for non-flying insects, e.g. Lygus). Inspection rates can vary within a season but for pheromone and egg traps, traps are checked typically at least once per week. Different sampling methods have different degrees of reliability, but typically the data can include noise. For example, a pheromone trap for navel orangeworm captures only adult male moths, relying on an estimate of the proportion of male insects in the overall population to estimate the total population including both male and female insects. Data analysis and entry into example system 100 can include manual counting, automated assessment using computer vision models (e.g., machine counting), weight-based counting, or other techniques.

In some embodiments, intervention data 170 describe prior interventions taken in the host environment. Intervention data 170 can be received from client computing device(s) 110, including but not limited to planting systems, by manual user input, and/or as part of outputting operations as described in more detail in reference to FIG. 2. In this way, it is contemplated that example system 100 will support iteration of models 145-150 using intervention actions to improve future performance of pest management actions with respect to one or more competing objectives.

As described in more detail in the forthcoming paragraphs, predictive model 145 generates predicted population data 350 (in reference to FIG. 3) for an optimizer model 310 by processing state data 210 and generating a predicted population dataset based at least in part on kinetic aspects of pest population development, such as a DEL parameter 340, as described in more detail in reference to FIG. 3. Predicted population data 350 are used to generate predicted intervention data 355 using an optimization routine for constraint model 150, for example, through one or more control schemes 317. Environmental data 130, population data 140, predicted population data 350, intervention data 170, and predicted intervention data 355 can be used as part of an optimization of constraint model 150 over one or more iterations, as described in more detail in reference to FIGS. 3-8.

FIG. 2 is a process flow diagram illustrating an example process 200 for modeling population dynamics of a pest, in accordance with embodiments of the disclosure. Example process 200 may be implemented by one or more constituent elements of example system 100 of FIG. 1, including but not limited to server(s) 105 and/or client computing device(s) 110. Example process 200 includes operations 201-209 for receiving environmental data 130 and generating pest intervention recommendations 240 using control model(s) 220 including predictive models 145 and constraint models 150 as part of an optimization of competing objectives including the presence of a pest in the environment and the resource demand and/or environmental impact of interventions over a prediction horizon 415 (in reference to FIG. 4B), also referred to as “H.” In the context of the present disclosure, prediction horizon “H” describes a period of time over which state data 210 is available from which population data 140 can be predicted for use in iterative optimization of control model(s) 220.

Example process 200 is illustrated as a series of operations 201-209 implemented by a computer system using models encoded in software. For example, the operations of example process 200 can include implementation of models 145 and 150, stored as computer-readable instructions in software 155 that are executed by computing circuitry 160 of server(s) 105. In some embodiments, the operations of example process 200 are divided between multiple systems. For example, at least a subset of the operations of example process 200 can be executed locally on client computing device 110, while a different subset of the operations of example process 200 can be executed on a distributed system of server(s) 105. For example, outputting operations can be executed on client computing device 110 as part of an interactive pest monitoring and/or management platform that solicits user feedback and provides notifications of pest population dynamics in advance and/or in near-real time, as part of scheduling and implementing intervention actions.

In this context, the term “near-real time” is used to refer to a delay in delivering pest population data within a time frame during which an intervention can be effectively staged. For example, an intervention recommendation can be characterized by a timing window on the order of days and a spraying operation can occupy a period of time of hours, such that a delay in receiving pest population data and/or intervention recommendations on the order of minutes or hours does not impair the effectiveness of the prediction. Similarly, where an intervention is time-sensitive on the order of hours, population data that is delayed by hours can still be effective if the data accurately describe future conditions more than one day in advance.

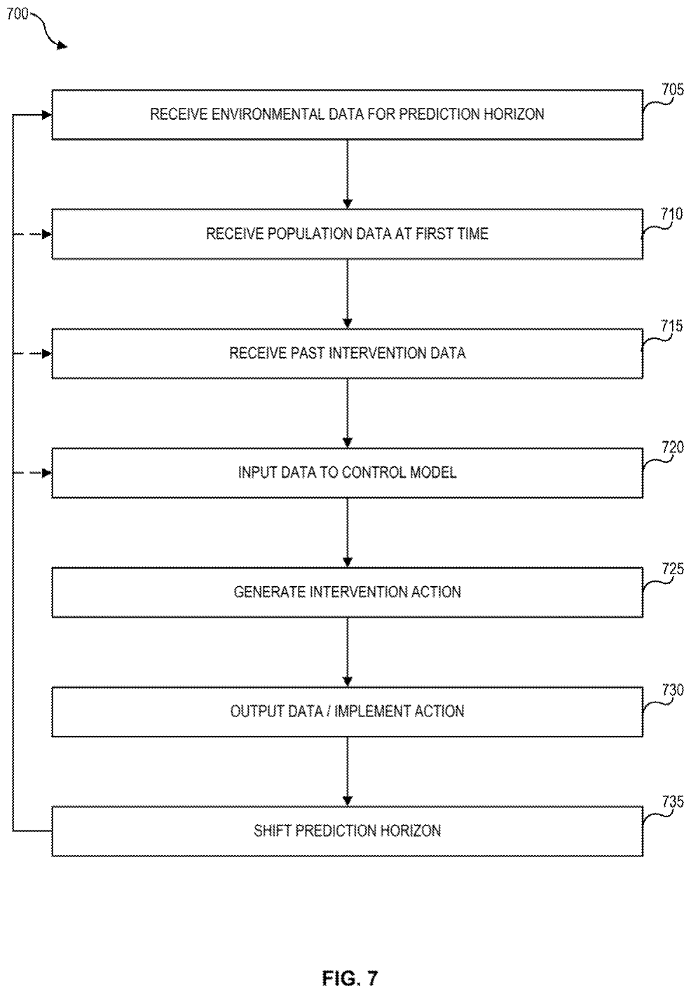

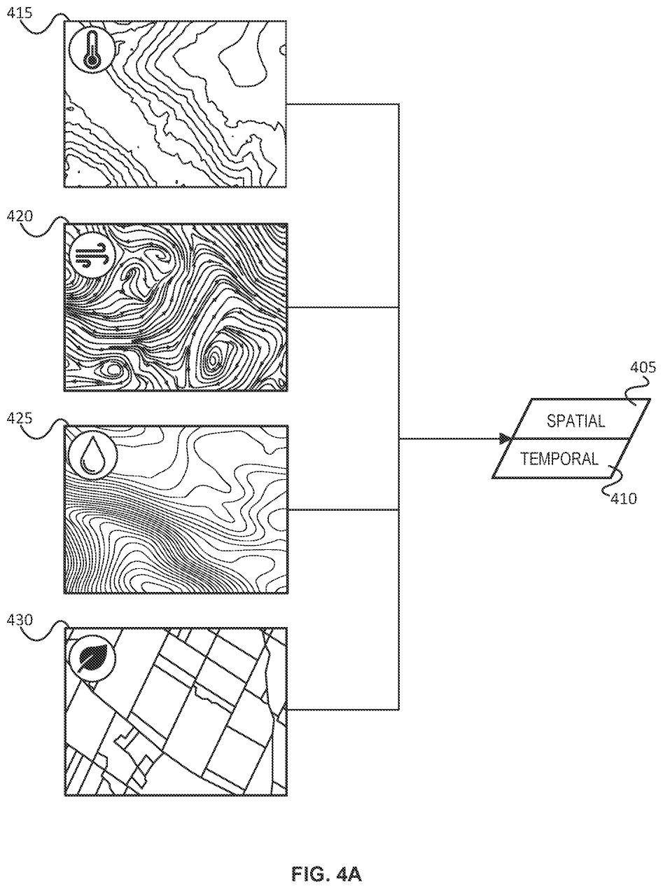

The order in which some or all of the process blocks appear in example process 200 should not be deemed limiting. Rather, one of ordinary skill in the art having the benefit of the present disclosure will understand that some of the operations can be executed in a variety of orders not illustrated, or even in parallel, with some operations omitted or with some optional operations included. Advantageously, operations 201-209 of example process 200 can be prioritized, parallelized, distributed, or otherwise coordinated to provide population and/or intervention data within a timeframe where it can be effective for the user, being informed, for example, by the temporal sensitivity of the data being generated. In this way, the performance of pest management systems, including automated systems, can be improved over that of fixed-schedule or reactive pest management systems, as described in more detail in reference to FIG. 7.

At operation 201, example process 200 includes receiving state data 210, including environmental data 130 and/or population data 140. Environmental data 130 can be received directly and/or indirectly from sources 115, for example, through operation of a data retrieval system configured to request environmental data 115 and/or to receive environmental data 115 according to a refresh cadence or other timing. For example, an application hosted on client computing device 110 can receive environmental data 130 from sources 115 via network 120. Pest population data 140 can be received from pest monitoring system(s) 117 directly (e.g., where pest monitoring includes sensor bearing systems that can communicate with server(s) 105 over network 120) and/or indirectly from client computing device(s) 110 (e.g., via a user-initiated upload). Client computing device(s) 110 and/or server(s) 105 can then process environmental data 130 locally to generate state data 210. In some embodiments, operation 201 can include communication of environmental data 130 between sources 115 and server(s) 105, where generation of state data 210 occurs at least in part on server(s) 105.

In some embodiments, environmental data 130 includes data for a plurality of physical locations as part of a spatiotemporal dataset, as described in more detail in reference to FIG. 4A. For example, environmental data 130 can include two-dimensional projection data (e.g., iso-contour maps) for atmospheric pressure, precipitation, wind speed, or the like, that can be developed by meteorological or other models using point-data measured by in situ sensors. As such, environmental data 130 can be received from sources 115 that are in situ (e.g., local sensors) and/or from computer systems that communicate with in situ sensors to generate estimated and/or predicted environmental data 130. Example system 100 can receive environmental data 130 through intermediary systems (e.g., publicly available weather data), rather than communicating directly with a network of sensors specific to the pest/host system. To address limitations in sensor networks and/or prediction systems, in some embodiments, operation 201 includes accessing multiple redundant data sources. Advantageously, accessing redundant environmental data 130 addresses delays in availability of environmental data 130 from any given source and further corrects for error by aggregating environmental data 130.

At operation 203, example process 200 can include receiving past intervention data 170. In the context of generating an intervention action 240 for the current time, prior intervention data can be propagated into future predictions as part of optimizing a constraint function over one or more growing seasons as well as over a prediction horizon. In an illustrative example, state data 210 can be received at operation 201 corresponding to a prediction horizon of four weeks. Optimizing for competing objectives of controlling the presence of a pest in the host environment by applying spray pesticide and reducing the impact of spraying on agricultural output can include imposing a constraint on the total quantity of pesticide applied per unit area. In this way, spray timings can be optimized to reduce predicted pest emergence over the prediction horizon while also minimizing the quantity of pesticide applied over the prediction horizon, as well as over the entire growing season, by propagating intervention data 170 from prior iterations of example process 200 and/or from other sources of intervention data 170.

At operation 205, example process 200 includes inputting data, including state data 210 and/or intervention data 170, to control model 220 configured generate intervention action 240 as part of optimizing a set of predicted intervention actions 355 over the prediction horizon 415 “H” (in reference to FIG. 4B). As described in more detail in reference to FIGS. 3-5, predictive models 145 can take in multiple inputs, including but not limited to environmental data 130, pest population data 140, and/or intervention data 170 corresponding to a period of time preceding prediction horizon “H.”

State data 210 can include fewer points of population data 140 than environmental data 130. As such, predictive model(s) 145 can be configured to generate predicted population data 350 (e.g., population density, pest emergence, etc.) that can be used to estimate pest population dynamics at a future time, temporally after the time for which intervention action 240 is generated. In an illustrative example, predictive model(s) 145 can be used to describe population density, cumulative population density, and emergence information at a second time point, temporally after a first time point of intervention action 240, for which population data 140 is unavailable. The first time point and the second time point can be separated by a time-step 420 (in reference to FIG. 4B) that can be a parameter of pest management system 320. The time-step can be on the order of minutes, hours, days, weeks, or longer, based at least in part on the time scale of a given intervention method and/or a sampling period of population data 140.

Pest population data 140 can be collected using pest monitoring system(s) 117 that are sampled and/or replaced according to a sampling period of about one week. To that end, the frequency of intervention actions can correspond with the sampling period (e.g., one recommendation per week) or can be more frequent or less frequent, depending on the time used to implement an intervention (e.g., where a spray intervention can be completed in less than one week and population data is based on weekly trap catches, intervention actions 240 can be generated more frequently than the sampling period). In some embodiments, the intervention period can be constrained by environmental restrictions, system limits, or other constraints. For example, the frequency of intervention actions of a given type (e.g., spraying, mite dispersal, or the like) can be limited by environmental constraints or logistical factors, where application is limited not only by total dose, but also by dose over time to impose a minimum period between intervention actions.

At operation 207, example process 200 includes generating intervention action 240 as the output of control model 220. As described in more detail in reference to FIG. 3, intervention action 240 corresponds to an entry in a set of predicted intervention data generated via an optimization of an intervention schedule over prediction horizon “H,” based at least in part on optimizing a value of constraint model 150. As described in more detail in reference to FIG. 1, constraint model can include terms to balances multiple competing objectives including but not limited to presence of the pest in the host environment, resource demands and logistical demands of intervention systems, impacts of interventions on the host environment, and/or impacts of inventions on the surrounding environment.

Control model 220 can include diverse model architectures and a number of different optimization paradigms implemented as an optimizer 310. As an illustrative example, optimization can include one or more approaches for model predictive control including but not limited to genetic algorithms, nonlinear constrained optimization techniques (e.g. trust region methods, active-set algorithms, sequential quadratic programming, or interior point algorithms), or graph-based searches of intervention data including a cost-optimized search algorithm. Nonlinear constrained optimization techniques (e.g., Pontryagin's principal or Hamilton-Jacobi-Bellman non-linear optimization), linear-quadratic regulator optimization, and/or reinforcement learning approaches (e.g., machine learning models) can be used to solve an optimal control problem over multiple prediction horizons for a period of time for which environmental data, state data, and/or intervention data are available. Additional and/or alternative approaches include graph-based searches of intervention data 170 using a cost-optimized search algorithm. Optimized search algorithms can include classic tree search algorithms, local search algorithms, or Monte Carlo search algorithms.

In the context of linear-quadratic regulator-based model-predictive control, control model 220 can implement predictive model(s) 335 as a set of linear differential equations (e.g., as PETE model described in reference to FIG. 3) and can implement constraint model 150 as a quadratic function. Optimization of a linear quadratic regulator involves minimizing constraint model 150, which can be defined as a sum of individual contributors to an overall impact of intervention actions over prediction horizon “H.” Iteratively modifying predicted intervention actions 355 and revising predicted population data 355 toward convergence permits control model 220 to determine intervention action 240 (e.g., immediately or as part of a scheduled pest management system).

For genetic algorithm approaches, optimizer model 310 can generate two or more parent sets of predicted intervention actions 355 (e.g., by random generation), from which a number of child sets can be propagated by various techniques (e.g., random combination, pseudo-random combination, etc.) and the child sets can be evaluated using constraint model 150. Optimizer 310 can iterate over multiple generations to converge one or more candidate sets of predicted intervention data 355 toward an optimized value of an objective function (e.g., a loss function, cost function, or the like), to evolve one or more elite candidates most likely to correspond to a presence of the pest in the host environment that is balanced with competing objectives, such as a reduced resource demand and/or logistical cost of interventions.

In the context of Hamilton-Jacobi-Bellman non-linear optimization, control model 220 implements a “value function” that represents the minimum value of a temporal integral of the constraint model 150 and a residual value at time T=H.

$${V}_{T} ( x ( 0 ) , 0 ) = {min}_{u} \{ {\int }_{0}^{T} C [ x ( t ) , u ( t ) ] dt + D [ x ( T ) ] \}$$

Where V_{T} is the value function, C is the constraint model, and D is the residual value as a function of predicted population data 350. In the context of pest management, the constraint model (accounting for competing objectives) can represent a population model with intervention effect and the residual value can be based on the pest information. As a discrete-time counterpart, the value function can be replaced by Bellman's equation, which can be solved with value iteration or policy iteration. In some cases, the residual value can represent a projected impact of the pest in the environment as a result of the remaining pest presence that can result in future damage to agriculture and/or the environment. Inclusion of the integral permits that minimization of the value function over the prediction horizon to represent the optimum solution for a control vector “u(t)” that represents the set of predicted intervention actions 355.

In the context of optimization in line with Pontryagin's principal, control model 220 can implement a minimization of an objective functional, J, defined for the system of pest population management as a function of state data 210 and intervention data 170 over time from a first time point, corresponding to the time of intervention action 240 to a time T=H.

J=Ψ(x(T))+∫₀^{T}L(x(t),u(t))dt

Where Ψ(x(T)) is defined as a partial derivative of the state function, evaluated at the endpoint of prediction horizon H, representing a residual state of the system. L represents a Lagrangian formulation of constraint model 150 that is integrated over time from the first time point to time T=H. The optimization is implemented by control model 220 at least in part by satisfying the four optimality conditions of Pontryagin's principal, as would be understood by a person skilled in the art of computer control. In some embodiments, the objective functional includes a discrete summation, rather than an integral, where state and intervention data are discrete time variables:

$$J ( x , u ) = {\sum }_{t = 0}^{H - 1} ℓ ( {x}_{t} , {u}_{t} ) + ϕ ( {x}_{t} )$$

There the term u(t) represents control inputs to pest management system 320 as a function of time, with values being generated as a function of predicted pest population data 355 in accordance with one or more control schemes 317. In the function above, Φ refers to additional terms not directly dependent on interventions and/or populations.

Additional terms “Φ” can include but are not limited to environmental and health related factors included as part of model predictive control. As an illustrative example, pesticides include harmful chemicals that can damage surrounding ecosystems when they make their way into rivers, lakes, and groundwater. This process is known as “pesticide leaching,” and heavy rainfall and irrigation increase the risk of leaching. To that end, Φ can include rainfall predictions from environmental data as an input to quantify runoff risk associated with spraying pesticides. In another example, the time prior to harvest can be an additional term that modifies weather pesticide application is permissible. For example, shortly before crop harvest, pesticide application can leave residue on the crop that can be harmful when consumed by humans. Similarly, the non-economic “cost” of pesticide application can increase during a window of time preceding a harvest to reflect that pesticide application is disfavored, but not impermissible.

Control model 220 can incorporate machine learning models that are trained to predict intervention action 240. In an illustrative example, a machine learning model can be trained to input state data 210 and intervention data 170 and to output a predicted set of intervention actions 355 (e.g., a sequence-to-sequence model such as an RNN, LSTM, or GRU model). Training can be based at least in part on a set of labeled training data from prior executed pest management operations and/or using synthesized data produced from model-predictive control simulations using other methods described herein. Advantageously, machine learning techniques can capture latent interactions between different constraints that can be less apparent and therefore excluded from analytical formulations of predictive model(s) 145 and constraint model(s) 150. In some embodiments, machine learning models can be trained to input a set of predicted intervention actions 355 and state data 210 and to output an optimized set of predicted intervention actions 355. As such, it is understood that such machine learning techniques can include training a model to approximate the behavior of the pest-host system in response to intervention actions.

In some embodiments, example process 200 includes outputting intervention action 240 at operation 209. Outputting operations can include electronic communication of intervention action 240 in a computer system, such as server(s) 105 and/or client computing device(s) 110 or between different systems, as in distributed networked systems and/or between server(s) 105 and client computing device(s) 110. In some embodiments, outputting operations include storing intervention action 240 and/or intervention data 170 in a data store, such as a memory device of server(s) 105 and/or client computing device(s) 110.

Similarly, outputting operations can include generating visualization and/or notification data and communicating the data to a user device or other associated device, such as a smartphone or an internet-connected piece of agricultural equipment. Agricultural equipment can incorporate many of the same types of electronic devices as client computing device 110 or smart phones. As such, operation 209 can include communicating with agricultural equipment, for example, over network 120, such that notifications and/or visualizations can be presented to a user of the agricultural equipment through display devices, acoustic speakers, or the like, that are incorporated into the equipment. In the example of a smartphone, the visualization and/or notification data can be formatted using standardized communication protocols, such that outputting can include sending a digital message including population data 240, intervention timing data, or other types of notifications, without a specialized application.

Outputting operations can also include communicating intervention action 240 with a pest management system 320 (in reference to FIG. 3). In some embodiments, outputting to pest management system 320 includes autonomous or semiautonomous initiation of an intervention actions 240. For example, intervention action 240 can be initiated through modifying a logistics system managing pest intervention equipment. Where the logistics system manages resource allocation, such as spray trucks, mite dispersal, trap teams, or other automated, pseudo-automated, or manual interventions, outputting intervention action 240 can include engaging an intervention resource 325 within a window of time corresponding to the first time point for effecting intervention action 240.

Following operations 207 and/or 209, example process 200 can be repeated over one or more iterations with updated state data 210 and/or intervention data 170 for an updated prediction horizon. For example, prediction horizon H can be shifted by one or more timesteps T to permit control model 220 to generate a second intervention action 240 corresponding to a second time temporally after the first time of a first intervention action 240.

FIG. 3 is a data flow diagram illustrating an example control system 300 for generating and implementing intervention actions, in accordance with embodiments of the disclosure. Example control system 300 can be implemented by one or more constituent elements of example system 100 of FIG. 1, including but not limited to server(s) 105 and/or client computing device(s) 110. Example control system 300 can include one or more algorithms encoded in software 155 including one or more iteration loops used to implement optimization of intervention action 240. Example control system 300 includes control model 220 implementing predictive model(s) 145 and an optimizer 310 configured to minimize constraint model 150 over prediction horizon H. Example control system 300 can include one or more pest management systems 320 deployed to monitor the presence of a pest in a host environment (e.g., pest monitoring system 117 of FIG. 1) and/or to effect intervention action(s) 240.

As described in more detail in reference to FIG. 2, control model 220 is configured to implement an optimization of a set of predicted intervention actions 355 over prediction horizon H, based at least in part on set of predicted population data 350 and constraints 315 included as part of constraint model 150. Over one or more iterations, competing objectives encoded in constraint model 150 can be balanced by modifying predicted intervention actions 355 and iteratively regenerating predicted population data 350. As described in more detail in reference to FIG. 7, generating intervention action 240 can form a part of a model-predictive control algorithm for managing the presence of a pest in the host environment, where updated state data 210 and intervention data 170 are provided to control model 220 for a new prediction horizon H following operation 207 of example process 200.

Selection of predictive model(s) 145 can be informed by details of the pest/host system. As an illustrative example, for insect pests, predictive model(s) 145 can include mechanistic models such as the Predictive Extension Timing Estimator (PETE) model 335. Other predictive models 145 for insect-pests include, but are not limited to, the Ricker model, the Lotka-Volterra model, and the spruce budworm model. Advantageously, predictive models 145 can be selected to account for particular pest population dynamics, which can be specific to a genus, species, or pest/host system. For example, the Lotka-Volterra model includes predator-prey interaction terms, and the spruce budworm model includes terms to account for outbreak dynamics. In this context, the term “outbreak dynamics” refers to a mechanism of pest proliferation that is infrequent and significant in extent. For example, an outbreak of spruce budworm in the Canadian province of Quebec in 2006 resulted in defoliation of approximately 3,000 hectares of forest after several decades of inactivity by the pest.

PETE model 335 implements a simplifying assumption that insect population development rate is determined primarily by ambient temperature. PETE model 335 assumes that the rate of development is directly proportional to the temperature in excess of some species-specific lower developmental threshold (just like degree days) and that the dynamics of emergence are governed by a delay differential equation (DDE). The PETE DDE takes the form of a system of k equations:

$$\frac{{dr}_{1}}{dt} = \frac{k}{DEL ( t )} ( I ( t ) - {r}_{1} ( t ) ( 1 + \frac{1}{k} \frac{DEL ( t )}{dt} ) )$$

$$\frac{{dr}_{2}}{dt} = \frac{k}{DEL ( t )} ( {r}_{1} ( t ) - {r}_{2} ( t ) ( 1 + \frac{1}{k} \frac{DEL ( t )}{dt} ) )$$

$$\frac{dy}{dt} = \frac{k}{DEL ( t )} ( {r}_{k - 1} ( t ) - y ( t ) ( 1 + \frac{1}{k} \frac{DEL ( t )}{dt} ) )$$

where I(t) represents the input population at time “t,” y represents the predicted emergence at a later time temporally after t, DEL 340 represents a delay parameter that is the reciprocal of the rate of development, rᵢ represents intermediate rates, and k represents the number of equations in the system.

The delay DEL(t) at each timepoint can be described by:

$$\begin{matrix}DEL ( t ) = {DEL}_{PETE} ( t ) \times {DEL}_{NN} ( t ) \\ = \frac{TDD}{max ( 0 , T ( t ) - {T}_{0} )} \times {f}_{θ} ( x ( t ) )\end{matrix}$$

where ƒ₇₄ represents ML model 145 and x(t) represents Environmental data 130 at time “t.” In some embodiments, DEL(t) is used to solve PETE model 335 above using a Euler solver with timestep dt=0.25 days to obtain the predicted emergence y(t).

In an illustrative example, PETE model 355 can be applied to model population dynamics of an individual life stage of an insect, for example the emergence of an adult insect from the pupal stage. In this context, the term “emergence” describes a change in population density of the adult insect over time. Since adult insects develop from pupae, “emergence” indicates a positive rate of change of the population density. In some embodiments, it is assumed that the total population of insects is conserved, such that the sum of the number of pupae and the number of adult insects remains constant over time. In some embodiments, additional dynamics are introduced into mechanistic model(s) 150 to account for parasitism, natural death of pupae and/or adult insects, and other factors. Such dynamics can include, but are not limited to, additional terms added to population equations to reduce the population of insects in either life stage.

For PETE model 335, the total emergence of insects is equal to the total number of input insects. In this way, solving the above system for y and dividing by the input population will return a population density that integrates to 1. In PETE model 335, the number of insects in the pupal stage serves as the initial population I(t). Insects emerge into the adult life stage after spending time in the pupal stage, the duration of which depends on the ambient temperature. Emergence as adult insects occurs after a time delay, reflected as a change in the adult population y(t).

It is assumed that the pupation stage can be described by “k” latent ‘micro-states’ that each insect must pass through before emergence, where “k” is an integer. The “r” variables in the above equations represent the population in each of the k latent micro-states as a function of time. It should be noted that the latent ‘micro-states’ do not correspond to instars or other physiological stages of insect development. Instead, each system of k equations describes a single life stage or generation (e.g. a model with k=6 does not represent six generations) that is accurately described by the simplifying assumptions of PETE model 335. In the context of example control system 300, latent micro-state emergence parameter rᵢ can be considered as a latent variable internal to the mechanistic model(s) 150.

As DEL(t) 340 is a term in each of the k rate equations, the rate of emergence of the adult stage depends on the rate of growth and on the number of intermediate stages. Timing of emergence and the shape of a population emergence curve are accurately described by an Erlang distribution with shape parameter k and time-dependent mean and variance:

$${μ}_{τ} ( t ) = DEL ( t )$$

$${σ}_{τ}^{2} ( t ) = \frac{{{μ}_{τ} ( t )}^{2}}{k}$$

where μ_{τ}(t) represents the mean value of the Erlang distribution for population density and σ_{τ}(t) represents the variance of the Erlang distribution. As such, DEL determines the location and width of the emergence curve and k its shape. In an illustrative example, k=1 produces an exponential distribution where population is proportional to e^{t}, while for larger values of k the population density distribution approaches a Gaussian distribution.

Ambient temperature information is incorporated into PETE model 335 through DEL term 340, defined as:

$$DEL ( t ) = \frac{TDD}{max ( 0 , T ( t ) - {T}_{0} )}$$

where TDD represents the mean number of accumulated degree-days to go through the stage of growth, T(t) is the temperature and To is the lower temperature threshold for growth. It is apparent that DEL(t) is undefined in circumstances where T(t) is below T₀. It is important to note that DEL is defined as the reciprocal of the rate of growth, defined as proportional to the temperature above the lower threshold temperature. In this way, where ambient temperature is less than the lower threshold temperature, the rate of growth is zero.

A limitation of PETE models 335 is that selecting the values for parameters used in TDD and k can be challenging. Where the mean and variance of emergence time for a population of insects are known, for example, from lab experiments, the Erlang mean and variance equations can be used to determine parameters. In some cases, heuristic-based techniques involve estimating a time to half-emergence of an insect from multiple in situ collections in different host environments over multiple growth seasons of the insect. From collection data, the time to half-emergence can be used to compute Erlang mean and variances, as the Erlang distribution is symmetrical about a central mean. It is noted, however, that both techniques present significant drawbacks. Using laboratory determined growth parameters can ignore the influence of Environmental data 130 other than ambient temperature. Similarly, collection data, based on samples taken from traps, can be labor intensive and produce inconsistent results that are also affected by environmental factors not accounted for in PETE models 335 (e.g., insect activity).

As a further limitation, fitting TDD and k parameters using gradient-descent from in situ trap data is difficult, as “k” is an integer, making the latent microstate equations not differentiable with respect to k. To address this limitation, in some embodiments, a value for “k” can be estimated using coordinate descent to alternately optimize TDD and k, where TDD is updated with standard gradient update with fixed k and k is then selected by exhaustive search on the training loss with fixed TDD.

In some embodiments, example control system 300 implements ML model(s) as part of predictive models 145 to generate input data for mechanistic model(s) such as PETE model 335. For example, input data can include values for the DEL function generated by inputting environmental data 130 including temperature data and other data, as described in more detail in reference to FIG. 4. Advantageously, ML model(s) can learn the nonlinear dependencies of DEL 340 on temperature and other weather and environmental factors. The system of “k” latent microstate equations can then be solved with the predicted value of DEL 340 to obtain predicted population density over time.

In some embodiments, PETE models 335 can include terms to account for one or more effects of interventions and other factors on the predicted emergence “y.” As an example, an attrition rate, AR(t) can be included as a function of time. Additionally or alternatively, an intervention effect term (1−u(t)) can be included, where u(t) represents the intervention condition at time “t” from first time tₒ to t=H. The expression for a PETE model 335 including the additional term is provided below:

$$\frac{dy}{dt} = ( 1 - u ( t ) ) \frac{k}{DEL ( t )} ( {r}_{k - 1} ( t ) - y ( t ) ( 1 + \frac{AR ( t ) \cdot DEL ( t )}{k} + \frac{1}{k} \frac{dDEL ( t )}{dt} ) )$$

Attrition, in the context of pest population dynamics, represents a sink term in the predicted emergence that does not correspond to transition from the current life stage or generation to the subsequent life stage or generation. For example, attrition can describe reduction of an emergence attributable to disease, predation, or other causes of reduction in emergence. As an illustrative example, models described herein can include predation dynamics, pest-disease dynamics, or the like. A predation rate can be expressed as:

$$h ( w ) = \frac{{w}^{2}}{1 + {w}^{2}}$$

where “h(w)” represents the predation rate as a direct modifier of the population growth rate that is dependent on the population “w,” a function of time and environmental factors.

Predicted population data 350, such as y(t) from PETE model 335, can serve as an input to optimizer 310, to be used as part of an optimization of the presence of the pest in the host environment against one or more constraints 315 as represented in constraint model 150. A general form of constraint model 150 for discrete-time data can include:

$$J ( {x}_{t} ) = {\sum }_{k - t}^{t + H - 1} [ θ {x}_{k} + ( 1 - θ ) {u}_{k} ]$$

where x(k) is a function of predicted population data 350, such as pest population density, at time k that represents the impact of the pest on crop yields, u(k) represents the “cost” of predicted intervention action 355 at time k, and Θ represents a tuning parameter between zero and one by which optimizer 310 can modify the relative emphasis placed on reducing pest populations as opposed to conserving intervention resources. For example, a larger value of Θ emphasizes the impact of the presence of the pest in the host environment relative to the importance of constraints 315. Where Θ is relatively small, the importance of resource demand, logistical factors, and/or environmental factors included as constraints 315 into constraint model 150 is emphasized by optimizer 310.

The nominal value of Θ can be tuned as part of optimizer 310 operations, as part of an optimization process over a longer timeframe than prediction horizon H. In an illustrative example, a season-long upper limit on spraying can be imposed by regulation, as part of environmental protections to reduce runoff into watercourses. As such, optimizer 310 can modify Θ toward smaller values as a growing season progresses, and/or as a function of the number of intervention actions 240 that contributed to the upper limit. Similarly, the type of intervention action 240 being determined for the timepoint can affect the value of Θ.

Predicted intervention actions 355 can be generated in accordance with one or more control schemes 317, based at least in part on predicted population data 355. For example, a Heaviside feedback control scheme 317 can be configured to return a false value for predicted pest population density or predicted pest emergence at time t=k that is below a threshold value and to return a true value for a density or emergence value above the threshold value. In this way, predicted intervention actions 355 can represent a sequence of Boolean values representing a schedule of intervention actions.

In some embodiments, multiple control schemes 317 can be implemented by optimizer 310 to account for system dynamics (e.g., pest emergence) indicated by predictive model(s) 145. For example, a feedback control scheme can include derivative terms indicative of rate of change, such that intervention action predictions are informed by pest emergence as well as nominal population density. In some embodiments, control schemes 317 inform the generation of an initial set of predicted intervention actions 355, after which optimizer 310 uses the optimization schemes described in reference to FIG. 2 to minimize constraint model 150.

For many pests, impact on crop yield is proportional to pest population, such that x(k) will be a linear function of pest population, where higher pest population will result in a greater damage extent. For example, xₖ can represent a constant slope linear function of pest population “P.” Direct correlation between pest population and reduction in crop yield can be expected in pest/host systems where the pest directly consumes or damages plants (e.g., herbivorous pests that consume leaf matter or fruits or lay eggs in fruits). An example of a direct pest is the Colorado potato beetle (Leptinotarsa decemlineata).

In some embodiments, xₖ can include an exponential term to account for nonlinear dependency of pest impact (e.g., crop damage) on pest population (e.g., pest density). The exponential term can include a power (‘p’), “xₖ^{p}” such that impact increases exponentially with pest population, which can be characteristic of secondary pests that are typically held in check by predation (e.g., spider mites) or that exhibit a transition from a solitary to gregarious behavior above a given threshold density (e.g., locusts).

In some embodiments, xₖ can include an inverse power

$${}^{″} {x}_{k}^{\frac{1}{p} ″}$$

that can be characteristic of a pest that is a vector of a crop pathogen. In such cases, a relatively low presence of the pest in the host environment can introduce a potentially catastrophic effect on crop yield. The dynamics of crop yield impact can be governed by other models more specific to the pathogen and its spread through the host environment, which can be pest agnostic. An example of a vector-pest is the pea aphid (Acyrthosiphon pisum).

The term uₖ can include one or more terms that represent the non-economic “cost” of implementing predicted intervention actions 355. For example, a continuous and differentiable factor between zero and one can be defined to reflect the progress toward a total permissible dose for a pesticide on a given area of land over a growing season (e.g., read into constraint model 150 as constraints 315), so that xₖ and uₖ can each be continuous and differentiable variables between zero and one. In some embodiments, the term uₖ can also include one or more terms that represent the economic “cost” of implementing predicted intervention actions 355. For example, a price-per-gallon of a pesticide product can be used to approximate an economic “cost” of a predicted intervention.

In some embodiments, uₖ represents an opportunity cost associated with allocating intervention resources 325 to one region rather than another. Pest management system 320 can include limited intervention resources 325 with relatively little redundancy or excess capacity, as an approach to reduce capital expenditure and maintenance/labor costs. As such, the “cost” of implementing predicted intervention actions 355 can include equipment prioritization and other logistical considerations. In an illustrative example, pest management system 320 can coordinate intervention resources 325 for multiple agricultural environments susceptible to infestation by different pests, each managed by application of respective chemical pesticides. In this way, constraints 315 can include information about existing allocations of intervention resources 325 as a function of time. In some cases, a portion of the environment can be treated, such that uₖ can reflect the portion of a constraint 315 representing the resource 325 allocation for the entire environment.

Embodiments of the present disclosure focus on spraying, but can also include other discrete and/or continuous interventions. In this context, the term “discrete” refers to an intervention that is applied at a specific time, such that intervention action 240 can be represented as a Boolean “true-false” for a given intervention type and a given time. The term “continuous” can refer to an intervention type that includes a proportion or other extent or magnitude factor or over a period of time including multiple time steps (e.g., continuously). For example, an intervention in a fruit orchard can be applied to a fraction of trees, in proportion to a population of a pest, such that uₖ can be a continuous value between zero and one. In some embodiments, categorical control variables representing different control types can be included as part of model predictive control operations of example process 200. For example, an exemplary intervention scheme can include multiple different pesticide types with different active ingredients.

Predictive model 145 can include a learned component implemented as a machine learning (ML) model. ML model(s) can be or include a fully-connected neural network model, a recurrent neural network model, a Long-Short Term Memory model, a gated recurrent unit model, or other model architectures capable of using state data 210 and intervention data 170 to estimate of DEL(t) (e.g., using environmental data 130 and intervention data 170 as an input). PETE model 335 can then generate predicted population data 355 that accounts for latent interactions between pest emergence and multiple environmental factors reflected in environmental data 130 in addition to ambient temperature effect.

As an example of nonlinear dependencies introduced by environmental factors, the presence of a pest can be described by activity and population density. Population describes the number of living pests, while activity describes a proportion of the population that is physiologically active in the environment at a given time. Activity may influence measurements of population and can introduce error in model predictions. For example, rain, wind and pesticide use can all reduce the number of flying moths captured in traps but might not impact the actual rate of development. Current sampling methods typically ignore environmental influence on activity, which can be accounted for through model corrections using environmental data 130. Advantageously, learned models can account for activity changes in response to environmental factors other than ambient temperature.

FIG. 4A is a schematic diagram illustrating example environmental data 130, in accordance with embodiments the disclosure. Environmental data 130 includes spatial data 405 and temporal data 410, allowing environmental data 130 to describe the state of a host environment in one or more spatial dimensions and in time. Environmental data 130, as described in more detail in reference to FIG. 1-3, can include data from multiple different sources, including temperature data 415, wind data 420, humidity data 425, land-use data 430, or the like.

Environmental data 130 can include temporal data 410 mapped to a geographic location of the host environment through spatial data 405. In some embodiments, environmental data includes values for temperature 415, wind 420, humidity, and land-use 430, but also can include precipitation, smoke, atmospheric pressure, or the like. In this way, introduction of ML elements into predictive model(s) 145 can model covariance between different spatial predictions at a given timepoint. Advantageously, such an approach can permit predictive models 145 to account for the influence of environmental conditions on intervention action 240 both spatially and temporally. In some embodiments, environmental data 130 include data for multiple physical locations, of which control model 220 generates intervention actions 240 for a subset of the physical locations. For example, a precipitation map can include data at a resolution higher than the predictive model(s) 145 can predict, based at least in part on limited resolution of other environmental data 130 or population data 140. In this way, intervention action 240 can be generated at a lower spatial resolution than environmental data 130.

Each data type can be expressed as a probability (e.g., a fraction or percentage), as a coded value, as a numerical value, or in other forms as may be received from the source(s) of environmental data 130. Each environmental data point can be associated with a timepoint and geographical coordinates, for example, through a GPS reference. As such, environmental data 130 can describe a multi-modal dataset in space and time for the host environment. In some embodiments, environmental data 130 is represented numerically by a tuple including a timepoint, spatial coordinates, and a value for each environmental data type being measured (e.g., an n-tuple where n is the number of entries in the datum).

With respect to land-use data 430, it is understood that some vegetation and/or land conditions can serve as direct hosts of pest organisms, some can serve as reservoirs of pest organisms, and some can serve as attractants or repellants for pest organisms. For example, wild land abutting a cultivated plot can serve as a reservoir of pest insects, where the wild land is not managed to limit the population of the pest. Similarly, crop rotation and other agricultural techniques can leave land fallow near a host environment, which can serve as a source of pest population. Land-use data 430 can encode one or more uses of land in the geographic area in and around the host environment. For example, land-use can be expressed numerically as a binary Boolean value, where true indicates host land and false indicates non-host land. In another example, land-use can be expressed numerically as a coded integer value, with each integer value corresponding to a different use. In some embodiments, land-use is classified from images by trained ML models, such that land-use can be expressed numerically as a probability that a given geographical position corresponds to cultivated land and/or as a host or reservoir environment. A probability value can provide a continuous and differentiable input to control model 220, for example, as an input to predictive model(s) 145 to reflect a source term from a pest reservoir.

FIG. 4B is a schematic diagram illustrating example state data 210 and example intervention data 170 as a function of time, in accordance with embodiments of the disclosure. For a series of timepoints 405, set of predicted intervention actions 355 are represented as discrete Boolean actions 410, respectively corresponding to a timepoint Tᵢ where “i” is an integer between 1 and “H,” with each value of “i” corresponding to a sampling frequency of pest population data 140 (e.g., using pest monitoring system 117). “H” represents the length of time of a prediction horizon 415 over which predicted pest population data 350 can be predicted using state data 210. Timepoints T are separated by timesteps 420, the duration of which can be based at least in part on a sampling frequency of pest monitoring system 117 and/or a minimum separation between intervention actions 410.

Prediction horizon 415 is illustrated as being the same length of time for population prediction and intervention prediction. In some embodiments, prediction horizon 415 for population prediction differs from prediction horizon 415 for intervention prediction. Some forms of intervention (e.g., spraying, mite dispersal, pheromone trapping, or the like) involve a prescribed course of intervention actions 410 including one or more periods of application/action and one or more periods of inaction. As such, intervention actions 410 can represent implementing an intervention (e.g., “taking an action”) or not implementing an intervention (e.g., “not taking an action”).

In an illustrative example, a set of predicted intervention actions 355 for spraying an orchard to reduce orange navelworm egg density can include multiple separate sprayings separated by a minimum period of time, such that prediction horizon 415 for interventions can include one or more timepoints T with actions and one or more timepoints T without actions, such that the total number of timesteps 420 exceeds the length of time for which environmental data 130 is available. Similarly, predicted intervention actions 355 can correspond to a shorter prediction horizon 415 than the length of time described by environmental data 130, for example, where timeframes for scheduling and/or implementing intervention actions 410 are limited, but environmental data 130 is available for longer terms.

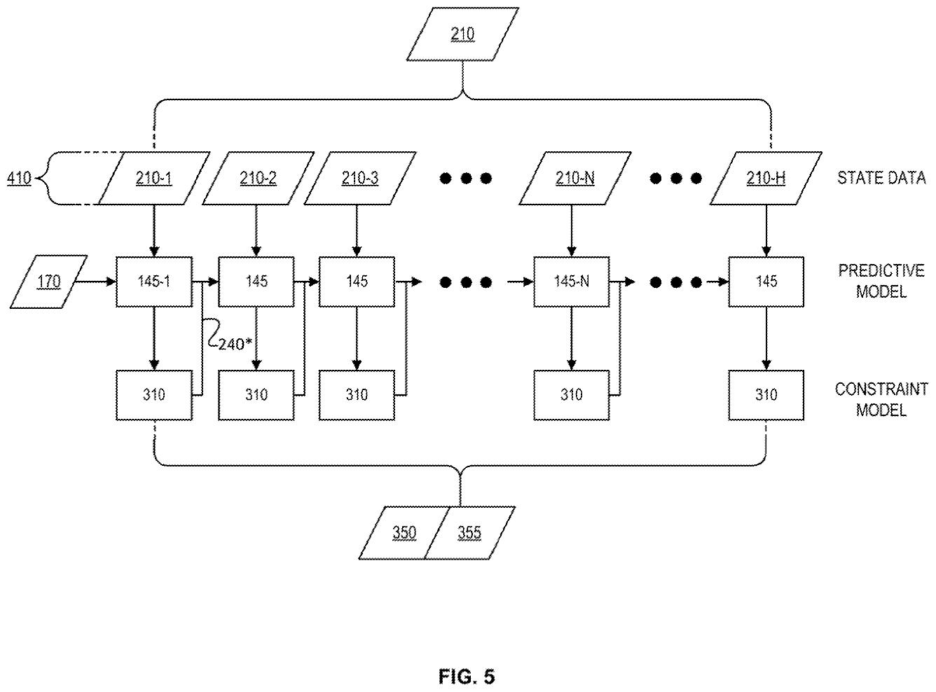

FIG. 5 is a schematic diagram illustrating example data flows for generation of predicted population data 350 and predicted intervention actions 355 for a prediction horizon 415, in accordance with embodiments of the disclosure. Data flows illustrated herein represent interactions between predictive model(s) 145 and constraint model(s) 150, as described in more detail in reference to FIGS. 1-3, which can include operations executed by server(s) 105 and/or client computing device(s) 110 and using state data 210 and intervention data 170 as inputs.

Model predictive control includes generating a set of predicted control inputs that converge constraint model 150 to an optimum (e.g., minimum, maximum, or target) value over prediction horizon H, for which intervention action 240 represents a control input for a first time point that is typically the next control action to be taken. As such, generating predicted intervention actions 355 for multiple timesteps (“T”) over prediction horizon 210 can include iteratively evaluating predictive model(s) 145 to generate a set of predicted population data 350 for timepoints T₁ to T_{H}. Similarly, predicted population data 350 can be used to generate predicted intervention actions 355 for timepoints T1 to TH in line with control schemes 317.

As illustrated, each iteration of predictive model(s) 145 includes inputting time-series state data 210, as well as the preceding value corresponding to intervention data 170 and population data 140. For example, a first iteration of predictive model(s) 145-1 receives as inputs a first timepoint of state data 210-1 and intervention data 170 (e.g., from third database 165). The output of first iteration of predictive model(s) 145-1 can be used by optimizer 310 to generate a predicted intervention action corresponding to the first timepoint. In line with the model-predictive control approach, of example control system 300, the predicted intervention action 355 corresponding to the first timepoint represents intervention action 240 when optimizer 310 has converged (FIG. 5 represents this conditional status with an asterisk “*”). For an “N^{th}” iteration of predictive model(s) 145-N, the output of a preceding iteration “N-1” of predictive model(s) 145-N-1 and the corresponding output of optimizer 310 are used, along with the Nth timepoint for state data 210-N, to populate the corresponding entry in predicted pest population data 350.

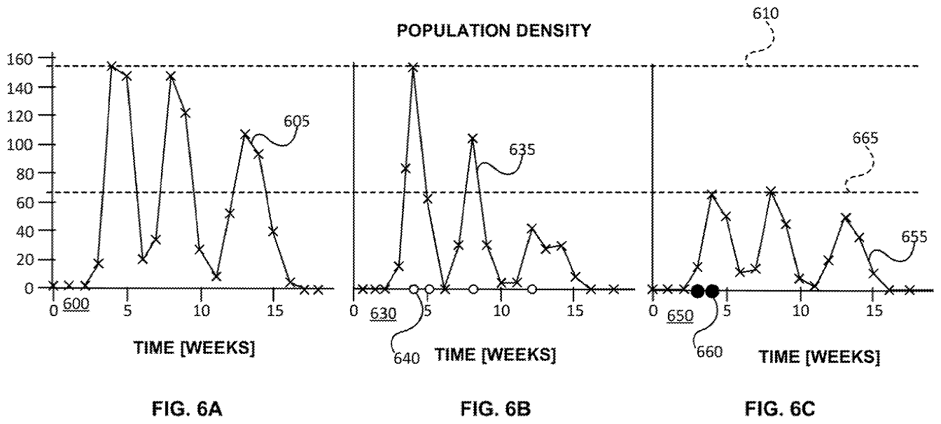

FIG. 6A is a graph 600 illustrating example population data as a function of time in a system without intervention, in accordance with embodiments of the disclosure. Graph 600 represents typical pest population data 140 for a host environment produced by an example embodiment of pest monitoring system 117. In the example of FIG. 6A, the pest host system is infestation of almond orchards by navel orangeworm (Amyelois transitella) in California, USA. In graph 600, population data includes multiple generations over a period of about 20 weeks, with a peak population density 610 corresponding to the first generation of approximately 155 insects per trap on average.

FIG. 6B is a graph 630 illustrating example population data as a function of time in a system with reactive intervention, in accordance with embodiments of the disclosure. Graph 630 demonstrates the impact of so-called “reactive” control that is typically implemented as a feedback control scheme using pest population data as an input to a model without a predictive component. Population data 635 of graph 630 is simulated using a simple feedback control model, with predictive model(s) 145 described in reference to FIG. 3 for the specific pest-host system of Lygus in strawberries. In contrast to graph 600 of FIG. 6A, population data 635 for graph 630 reflects the impact of four simulated intervention actions 640 taken approximately at 4 weeks, 5 weeks, 8 weeks, and 12 weeks over the same 20 week growing period. In the simulation, interventions 640 correspond to spraying pesticide. The reactive control scheme indicates an improvement in pest population over multiple generations, with the duration of each generation being shortened and the peak populations in second and third generations being reduced relative to population data 605 of graph 600. Peak population 610 remains approximately 155 insects per trap, however, revealing a relative weakness of reactive control schemes. Pest management systems can include sources of latency in control systems, such that a control input based on current population data 140 can be implemented after populations have continued to rise. This effect is demonstrated in graph 330, in that initial growth in population data 635 is not reduced relative to the corresponding untreated dataset 605 of graph 600. Population data 635 for the second and third generations reveal the progressive effect of the four interventions 640, with a reduction in peak populations in contrast to corresponding data in graph 600. By integrating the population curve over the growing season, reactive control reduces the total emergence relative to unmanaged crops by 47%.

FIG. 6C is a graph 650 illustrating example population data 655 as a function of time in a system with predictive intervention described in reference to FIGS. 1-5, in accordance with embodiments of the disclosure. In contrast to the simulated data in graph 630, population data 655 reflects the improvements to pest management system 320 provided by model predictive control of pest populations in line with the embodiments of example process 200 and example control system 300. With fewer interventions 660, at 3 weeks and 4 weeks into the roughly 20 week growing season, peak managed pest population 665 is reduced significantly, from approximately 155 insects per trap to approximately 65 insects per trap. While Lygus is a direct consumer of fruit seeds, the early-stage of development of fruit affected by Lygus can also reduce pollination of flowers, which introduces higher order and other non-linear dynamics into the pest-host system between population 665 and reduction in crop yield.

As shown, model predictive control results in reduced peak and total populations, corresponding to a 59% reduction in pest emergence, with half as many interventions 660 that take place earlier in the growing season and are not repeated. Advantageously, the model predictive control scheme illustrated in graph 660 also represents an improvement in management system 320 performance by facilitating more efficient use of intervention resources 325. For example, with spraying for the host environment concluded within the first five weeks of the growing season, spray equipment can be reallocated to other locations and/or repurposed for other pests. Similarly, with advanced prediction of pest emergence, resources 325 can be provisionally allocated in anticipation of interventions. In this way, fleet distribution and material supply issues can be addressed in advance, reducing latency introduced by logistical systems and/or labor shortages. Furthermore, optimization of competing objectives that is handled by control model 220 balances the environmental impact, material and resource costs, and labor and equipment time of interventions 660 against the reduction in yield of fruit harvests in a way that is absent from reactive control shown in graph 630.

FIG. 7 is a block flow diagram illustrating an example method 700 for controlling the presence of a pest in a host environment, in accordance with embodiments of the disclosure. Example process 700 describes an example of operations implemented by a computer system (e.g., server(s) 105 of FIG. 1) as part of deploying example process 200 of FIG. 2. The order in which some or all of the process blocks appear in process 700 should not be deemed limiting. Rather, one of ordinary skill in the art having the benefit of the present disclosure will understand that some of the process blocks can be executed in a variety of orders not illustrated or in parallel and can be repeated, omitted, or assigned to other systems.

At block 705, the computer system receives environmental data 130 for a prediction horizon H (e.g., prediction horizon 415 of FIG. 4B). As described in more detail in reference to FIG. 1-5, environmental data 130 can be or include measured and/or predicted data describing a host environment for a pest/host system. Environmental data 130 can be received from one or more sources including weather systems (e.g., weather forecast data), in situ sensors (e.g., meteorological sensor stations), internet connected sensor-bearing devices (e.g., agricultural vehicles, mobile electronic devices, etc.), by manual entry by human users. In some embodiments, data are received separately from multiple sources, such that the computer system, as part of operations at block 705, synthesizes environmental data 130 from the disparate source data. For example, each data source can be configured for a different sampling period, such that preparation operations can include sub-sampling at least some of the source data such that each entry of environmental data 130 includes a complete set of environmental measurements for each timepoint.

Environmental data 130 can be processed into other forms to be suitable for use as inputs to predictive model(s) 145. For example, predictive model(s) 145 can be configured to input derived parameters (e.g., DEL parameter 340 of FIG. 3) that can be determined using one or more models (e.g., trained ML models, heuristic models, estimations derived from pest monitoring system 117 data) configured to generate predicted DEL parameters using environment data 130. Advantageously, using environmental data 130 as part of state data 210 can improve the performance of pest management system 320 and control model 220, at least in part due to a relative infrequency of samples from pest monitoring system 117 and the possibility of noisy data caused by sparse sampling.

At block 710, the computer system receives population data 140 generated by pest monitoring system(s) 117 for a first time point. As described in more detail in reference to FIG. 1, pest monitoring system(s) 117 can include manual, automated, or pseudo-automated systems, devices, or techniques for assessing the presence of a pest in the host environment. In an illustrative example, pest monitoring system 117 can include multiple pheromone traps distributed through an almond orchard and periodically replaced to gather time-series data for the emergence of a navel orangeworm pest. Population data 140 received at block 710 can include timepoints preceding the first time, such that predictive model(s) 145 can include prediction based on environmental data 140 and on emergence dynamics (e.g., derivative terms).

At block 715, the computer system receives past intervention data. As illustrated in FIG. 6C, intervention actions can have lasting effects on pest emergence, which can be accounted for in predictive model(s) 145. As such, past intervention data 170 can be used as part of generating predicted intervention data 355, as described in more detail in reference to FIG. 3 and FIG. 5. Where no interventions have been implemented, or are otherwise not considered for predictive model(s) 145, block 715 can be omitted from example method 700.

At blocks 720-725, the computer system inputs data received at blocks 705-715 to control model 220 and generated intervention action 240. as described in more detail in reference to FIGS. 2-3, control model 220 is configured to implement model-predictive control-based optimization of a set of predicted intervention actions 355 over prediction horizon H, of which the predicted intervention action 355 corresponding to a first time point is outputted as intervention action 240. Optimization includes balancing competing objectives, such as crop damage due to pest presence, resource allocation constraints, equipment allocation constraints, labor allocation constraints, environmental restrictions on timing and extent of intervention, or the like. As such, through iterative optimization of the set of predicted intervention actions 355, intervention action 240 can be determined that guides the pest-host system toward an optimum state at timepoint T_{H}. It is understood that the optimum state may not correspond to the absolute minimum possible pest emergence over the prediction horizon, as pest emergence is balanced against other constraints that may limit the number and magnitude of interventions indicated.

In some embodiments, the computer system outputs intervention action 240 or other data (e.g., input data 220, environmental data 130) at block 730. Outputting operations, as described in more detail in reference to FIG. 2, can include storing data, including data for intervention action 240 and/or predicted data 350-355 on one or more storage systems. Outputting operations can also include communicating data to associated systems (e.g., client computing device(s) 110, pest management system 320, etc.), as through notifications and audio-visual information for presentation to a user. Additionally or alternatively, outputting operations can include implementing interventions directly, as when pest management system 320 includes automated (e.g., without human involvement) or pseudo-automated (e.g., with human oversight or control) intervention systems, such as sprayer systems or automated deployment systems, as when an unmanned aerial vehicle deploys pest predator organisms to control pest populations (e.g., Persimilis to attack spider mites) or autonomous spraying systems can at least partially prepare intervention resources 325 for implementing intervention action 240 (e.g., scheduling a spray event, allocating spray equipment, initiating a spray action, configuring spray equipment, or the like).

At block 735, the computer system iterates example method 700 by shifting prediction horizon H by one or more timepoints and repeating at least a subset of blocks 705-730. In some embodiments, data are available for more timepoints than what are included in prediction horizon H. As such, block 735 can shift the prediction horizon H by selecting a new set of data already stored in databases of server(s) 105 or client computing device(s) 110. In line with the principals of model-predictive control, implementing intervention action 240 at a first timepoint can be followed by shifting prediction horizon H forward (e.g., to exclude first timepoint and to cover timepoints T₂ to T_{H+1}) and repeating prediction and optimization operations using constituent models of control model 220 to generate a second intervention action 240.

The processes explained above are described in terms of computer software and hardware. The techniques described can constitute machine-executable instructions embodied within a tangible or non-transitory machine (e.g., computer) readable storage medium, that when executed by a machine will cause the machine to perform the operations described. Additionally, the processes can be embodied within hardware, such as an application specific integrated circuit (“ASIC”) or otherwise.

A tangible machine-readable storage medium includes any mechanism that provides (i.e., stores) information in a non-transitory form accessible by a machine (e.g., a computer, network device, personal digital assistant, manufacturing tool, any device with a set of one or more processors, etc.). For example, a machine-readable storage medium includes recordable/non-recordable media (e.g., read only memory (ROM), random access memory (RAM), magnetic disk storage media, optical storage media, flash memory devices, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. A computer implemented method for controlling a population of a pest, the method comprising:
receiving population data describing a presence of a pest in a host environment at a first time;
receiving environmental data describing the host environment over a prediction horizon including and temporally after the first time;
generating an intervention action for the first time using the population data and the environmental data as inputs to a control model configured to output the intervention action as part of an optimization of the presence of the pest over the prediction horizon; and
outputting the intervention action.

2. The computer implemented model of claim 1, wherein the control model comprises:
a predictive model configured to input the population data, the environmental data, and intervention data, and to output a predicted population density for the pest in the host environment at a timepoint of the prediction horizon temporally after the first time; and
an optimizer model, configured to input the predicted population density and to output an intervention recommendation by optimizing a constraint model.

3. The computer implemented method of claim 2, wherein the predictive model comprises a Predictive Extension Timing Estimator (PETE) model with an intervention term, the intervention term modifying the PETE model to account for the effect of the intervention action on a pest emergence as a function of time.

4. The computer implemented method of claim 2, wherein generating the intervention action comprises:
generating a set of predicted population density data for the pest over the prediction horizon using the environmental data, the population data, and the intervention data;
generating a set of predicted intervention actions for the prediction horizon using the set of predicted population density data as inputs to the optimizer model;
determining a value of the constraint model for the set of predicted intervention actions, wherein the constraint incorporates information for the presence of the pest in the host environment and the set of predicted intervention actions; and
iteratively updating the set of predicted population density and the set of predicted intervention actions until a convergence criterion is satisfied for the value.

5. The computer implemented method of claim 4, wherein the constraint model includes:
a first term for the damage caused to the host environment by the pest; and
a second term for the resource demand attributed to the predicted intervention actions.

6. The computer implemented model of claim 4, wherein generating the set of predicted intervention actions comprises a cost-optimized search of a database of intervention data.

7. The computer implemented model of claim 4, wherein generating the set of predicted intervention actions comprises:
randomly generating two parent sets of predicted intervention recommendations over the prediction horizon;
initializing a genetic algorithm using the two parent sets, wherein the genetic algorithm is configured to populate an initial generation of child sets using the parent sets, to determine respective optimization factors for the child sets, and to select two or more retained child sets by comparison of the respective optimization factors;
re-initializing the genetic algorithm using the retained child sets; and
iterating the genetic algorithm over one or more subsequent generations until a marginal improvement threshold is satisfied.

8. The computer implemented model of claim 4, wherein generating the set of predicted intervention actions comprises a non-linear constrained optimization of the set of predicted intervention actions and the set of predicted pest population data for the prediction horizon.

9. The computer implemented model of claim 4, wherein the convergence criterion comprises a comparison of a marginal reduction of the value of the constraint model with a threshold value.

10. The computer implemented model of claim 1, wherein the population data is first population data, the environmental data is first environmental data, the prediction horizon is a first prediction horizon, the intervention action is a first intervention action, and wherein the method further comprises:
receiving second population data describing the presence of the pest in the host environment at a second time temporally after the first time;
receiving second environmental data describing the host environment over a second prediction horizon temporally after the second time; and
generating a second intervention action for the second time using the second population data, the second environmental data, and the first intervention recommendation as inputs to the control model.

11. The computer implemented method of claim 1, wherein the intervention action indicates no action at the first time.

12. The computer implemented method of claim 1, wherein outputting the intervention action comprises outputting data for the intervention action to a pest management system.

13. At least one machine-accessible storage medium that provides instructions that, when executed by a machine, will cause the machine to perform operations comprising:
receiving population data describing a presence of a pest in a host environment at a first time;
receiving environmental data describing the host environment over a prediction horizon including and temporally after the first time;
generating an intervention action for the first time using the population data and the environmental data as inputs to a control model configured to output the intervention action as part of an optimization of the presence of the pest over the prediction horizon; and
outputting the intervention action.

14. The at least one machine-accessible storage medium of claim 13, wherein the control model comprises:
a predictive model configured to input the population data, the environmental data, and intervention data, and to output a predicted population density for the pest in the host environment at a timepoint of the prediction horizon temporally after the first time; and
an optimizer model, configured to input the predicted population density and to output an intervention recommendation by optimizing a constraint model.

15. The at least one machine-accessible storage medium of claim 14, wherein the predictive model comprises a Predictive Extension Timing Estimator (PETE) model with an intervention term, and wherein the intervention term modifies the PETE model to account for the effect of the intervention action on a pest emergence as a function of time.

16. The at least one machine-accessible storage medium of claim 14, wherein generating the intervention recommendation comprises:
generating a set of predicted population density data for the pest over the prediction horizon using the environmental data, the population data, and the intervention data;
generating a set of predicted intervention actions for the prediction horizon using the set of predicted population density data as inputs to the optimizer model;
determining a value of the constraint model for the set of predicted intervention actions, wherein the constraint incorporates information for the presence of the pest in the host environment and the set of predicted intervention actions; and
iteratively updating the set of predicted population density and the set of predicted intervention actions until a convergence criterion is satisfied for the value.

17. The at least one machine-accessible storage medium of claim 16, wherein the constraint model includes:
a first term for the damage caused to the host environment by the pest; and
a second term for the resource demand attributed to the predicted intervention actions.

18. The at least one machine-accessible storage medium of claim 16, wherein generating the set of predicted intervention actions comprises a non-linear constrained optimization of the set of predicted intervention actions and the set of predicted pest population data for the prediction horizon.

19. The at least one machine-accessible storage medium of claim 16, wherein the convergence criterion comprises a comparison of a marginal reduction of the value of the constraint model with a threshold value.

20. The at least one machine-accessible storage medium of claim 13, wherein the population data is first population data, the environmental data is first environmental data, the prediction horizon is a first prediction horizon, the intervention action is a first intervention action, and wherein the instructions, when executed by the machine, cause the machine to implement further operations comprising:
receiving second population data describing the presence of the pest in the host environment at a second time temporally after the first time;
receiving second environmental data describing the host environment over a second prediction horizon temporally after the second time; and
generating a second intervention action for the second time using the second population data, the second environmental data, and the first intervention recommendation as inputs to the control model.
